(19) United States
(12) Patent Application Publication
(10) Pub. No.: US 2004/0219889 A1
(43) Pub. Date: Nov. 4, 2004

(54) Phase-combined transmitter module and modular transmitter system

(76) Inventor: Walter Honcharenko, Monmouth Junction, NJ (US)

Correspondence Address: HARNESS, DICKEY & PIERCE, P.L.C., P.O. Box 8910, Reston, VA, 20195, US

(21) Appl. No.: 10/424,693

(22) Filed: Apr. 29, 2003

(51) Int. Cl. H04B 1/02

(52) U.S. Cl. 455/91; 455/118

(57) ABSTRACT

A transmitter module is provided that includes a discrete-coefficients phase-combiner and an analog-coefficients phase combiner sandwiched on either side of a middle section having at least a bank of up-converters and a bank of amplifiers. Despite a transmission scenario changing, e.g., by the addition of another carrier frequency, it is not necessary to replace the transmitter module with new equipment. Rather, the transmitter module can be retained and reused in combination with an additional transmitter module whose software aspects (discrete-coefficients phase-combiner) can be tuned so that the transfer function of the additional transmitter module matches the transfer function of the retained transmitter module.

### BACKGROUND OF THE INVENTION

Butler matrix amplifiers (also known as hybrid matrix amplifiers) are known and are popular.

A transmitter based upon a Butler matrix amplifier arrangement (BMAA), referred to as a BMAA transmitter, is a known power-balancing arrangement having three sections: an input section that receives intermediate-frequency (IF) analog signals; a middle section; and an output section. Both the input and output sections have a Butler matrix phase-combiner. The middle section includes an up-converter and an amplifier.

The design of a BMAA transmitter is based on the number of sectors and carrier frequencies to be used, whether or not an intelligent antenna technique will be used, the amplifier behavior, etc. Once the BMAA transmitter is designed, then the characteristics of the input Butler matrix phase-combiner and the output Butler matrix phase-combiner can be determined. Finally, the respective characteristics of the input and output sections of the BMAA transmitter according to the Background Art are implemented entirely by RF analog components.

To change anything about the BMAA transmitter, e.g., add a carrier frequency, it is not possible to modify or adapt the existing BMAA transmitter because of the input section having been implemented entirely by analog components. Rather, the existing BMAA transmitter must be discarded in favor of a new BMAA transmitter.

Transmitter equipment represents a large capital investment for wireless service-providers. As such, wireless service-providers generally prefer to invest in a transmitter that has a small margin of excess capacity relative to current transmission needs because that reduces the capital investment, despite the hope and/or reasonable likelihood that the transmission needs will grow as the wireless-service provider's market share increases. Moreover, the wireless service-provider desires to depreciate the capital investment (sunk cost) represented by the transmitter, which should be understood to mean that the wireless service-provider hopes to keep the transmitter equipment in service for as long as possible.

When the wireless service-provider wishes to increase transmission capacity, e.g., by adding a carrier frequency, it faces a dilemma. Because the BMAA transmitter has an input section implemented entirely by analog components, it cannot be modified or adapted to accommodate the increase in capacity. Rather, it must be discarded and replaced. Replacing the old transmitter equipment with new transmitter equipment prematurely terminates the depreciation of the old equipment. But not replacing the old equipment raises the problem that the wireless service-provider is postponing growth in its market share, which may be seized by a competitor if the wireless service-provider waits too long.

### SUMMARY OF THE INVENTION

If a transmitter based upon a Butler matrix amplifier arrangement can be made reconfigurable, then the trade-off between terminating the depreciation of equipment that must be replaced versus postponing an increase in transmitter capacity (as a response to an opportunity to increase market share) can be avoided. According to an embodiment of the invention, a transmitter module is provided that includes a discrete-coefficients phase-combiner and an analog-coefficients phase combiner sandwiched on either side of a middle section having at least a bank of up-converters and a bank of amplifiers.

According to an embodiment of the invention, even if the transmission scenario (to which this transmitter module is applied) changes, it is not necessary (according to the invention) to replace the transmitter module with new equipment. To the extent that the original transmitter module cannot accommodate the new transmission scenario, one or more transmitter modules can be added to define a new system that includes the original transmitter module. The software aspects of the discrete-coefficients phase-combiner, e.g., discrete gain and phase coefficients, in each additional transmitter module can be tuned so that the transfer function of the additional transmitter module matches the transfer function of the retained/original transmitter module. As such, a transmitter system employing such a transmitter module is both reconfigurable and scalable so as to be adaptable to changes in the transmission scenario to which it is applied. Depreciation of the original transmitter module can be continued despite the purchase of new equipment because the original transmitter module is not replaced, rather it is retained and reused (is included) within a new reconfigurable, scalable system.

### BRIEF DESCRIPTION OF THE DRAWINGS

Embodiments of the invention will become more fully understood from the detailed description given that follows and the accompanying drawings which are given by way of illustration only, wherein like reference numerals designate corresponding parts in the various drawings and the drawings are not drawn to scale unless noted, and wherein:

FIG. 1 is a block diagram of a phase antenna and six-way transmitter module according to an embodiment of the invention;

FIG. 2 is a block diagram of a modular transmitter system according to an embodiment of the invention;

FIG. 3 is a block diagram of another modular transmitter system according to an embodiment of the invention;

FIG. 4 is a block diagram of another modular transmitter system according to an embodiment of the invention;

FIG. 5 is a block diagram of another modular transmitter system according to an embodiment of the invention;

FIG. 6 is a flowchart of modular transmitter reconfiguration according to an embodiment of the invention.

FIG. 7 is a higher level (relative to FIG. 1) block diagram of a three-way transmitter module according to an embodiment of the invention;

FIG. 8 is a schematic block representation of the reconfigurable software aspects of the discrete-coefficients phase-combiner of FIG. 2; and

FIG. 9 is a block diagram of a six-way transmitter module according to an embodiment of the invention and corresponding calibration arrangement for the transmitter module according to an embodiment of the invention.

### DETAILED DESCRIPTION OF EMBODIMENTS

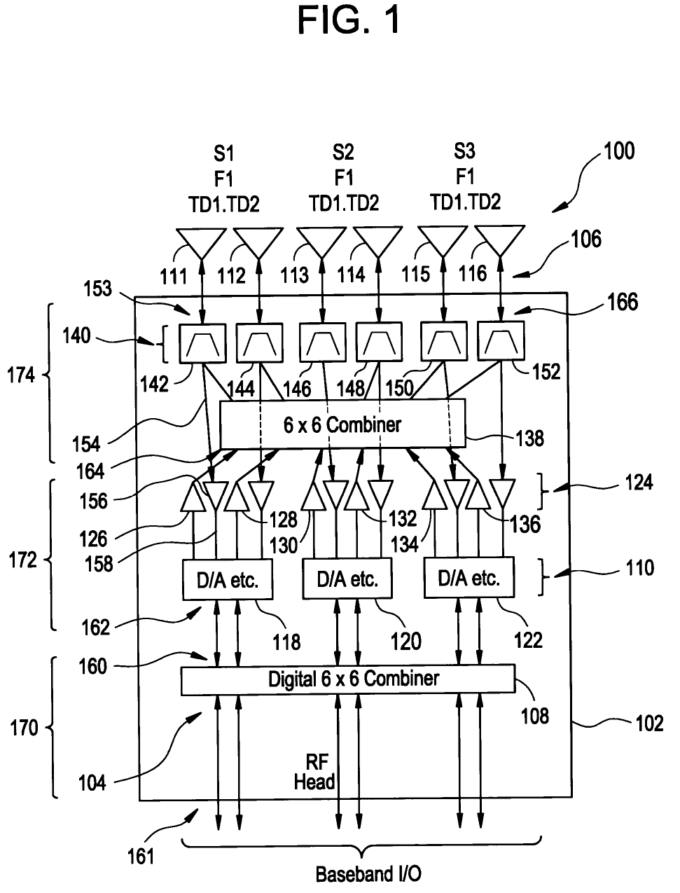

FIG. 1 is a schematic block diagram of a transmitter system 100 of antennas 111-116 and a transmitter module 102. The transmitter module 102 has an input section 170 that receives digital baseband signals, a middle section 172 and an output section 174. The input section 170 includes a discrete-coefficients phase-combiner 108 that operates on the digital baseband signals and outputs digital signals to the middle section 172 which includes a bank 110 of standard radio units 118-122. It is noted that transmitter module 102 also has receive paths, which are discussed below.

The phase-combiner 108 is referred to as a discrete-coefficients phase-combiner to indicate that it is not implemented entirely by analog components, rather the coefficients of the phase-combiner's transfer function are stored as digital numbers, e.g., via a memory device. The modifier “discrete-coefficients” should be understood as contrasting the phase-combiner 108 with the corresponding phase-combiner according to the Background Art, whose coefficients are implemented entirely via analog components.

Outputs of the radio bank 110 are amplified by a bank of amplifiers 124 and provided to an analog-coefficients phase-combiner 138 in the output section 174. An analog-coefficients phase combiner 138 does not have discrete coefficients, rather the coefficients are implemented with analog components. It is to be noted that a standard radio unit, e.g., 118, and an amplifier can be considered an up-conversion-and-amplification unit. Outputs of the analog-coefficients phase-combiner 138 can be put through a bank 140 of optional known bandpass filters 142-152. The filtered signals are provided to the antennas 111-116, respectively; alternatively, the outputs of the analog-coefficients phase-combiner 138 can be provided directly to the antennas 111-116, respectively.

The filters 142-152 limit the amount of noise leaked to adjacent frequency bands. Typically, the passband of the filters 142-152 is about 20 MHz for systems compliant with the personal communication services (PCS) standard and about 60 MHz for a system compliant with the international mobile telecommunications (IMT) standard.

The transmitter system 100 of FIG. 1 assumes the circumstance in which the transmitter module 102 has six inputs and six outputs. One of ordinary skill in the art will understand: that the transmitter module 102 has an equal number of inputs and outputs, Q; that Q is an integer; and that Q can vary such that Q≧2. Here, providing the module 102 with 6-inputs and six outputs, i.e., making it a six-way module (Q=6), is well suited to systems that use a three sector scenario with two antennas per sector. But it bears repeating that transmitter modules according to embodiments of the invention are not necessarily limited to being 6-way (Q=6), rather (again) Q≧2. A transmitter system according to embodiments of the invention can have plural transmitter modules, each of which should have the same Q.

The transmitter module 102 can be used with a variety of wireless standards, e.g., CDMA, CDMA 2000, UMTS, etc.

FIG. 1 also assumes that the 6-way transmitter module 102 accommodates a system having one carrier frequency, F1, three sectors S1, S2 and S3, with each sector having a first transmit-diversity branch TD1 and a second transmit-diversity branch TD2. But it is to be understood that the number of frequencies, the number of sectors, whether or not an intelligent antenna technique is used and whether or not transmit diversity is used are not limitations upon the invention; rather, these are design considerations that will vary with the circumstances to which the invention is applied.

The discrete-coefficients phase-combiner 108 is a Butler-type (but not a “pure” Butler matrix) phase-combiner. A pure Butler matrix phase-combiner would be a 2^{P}-way combiner where P is a positive integer, i.e., it has 2^{P} inputs and 2^{P} outputs or Q=2^{P} In contrast, phase-combiners (both digital and analog) according to embodiments of the invention are not limited to being 2^{P}-way. As such, discrete-coefficients phase-combiners according to embodiments of the invention are referred to as Butler-type phase-combiners.

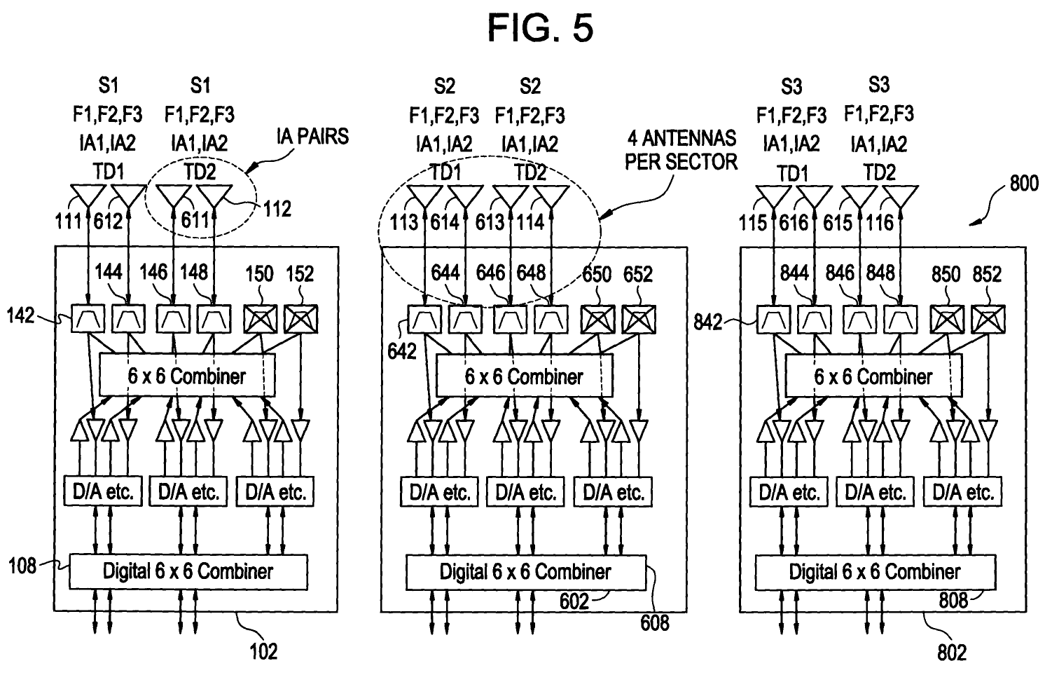

Scaling up (a type of reconfiguring of) a transmitter system typically is understood as at least adding a carrier frequency, although scaling up can include keeping the same number of carrier frequencies but switching from a non-intelligent-antenna approach to an intelligent-antenna approach. Adding capacity for additional carriers to one or more transmitter modules according to embodiments of the invention typically involves adding additional transmitter modules (that are substantially the same as the retained transmitter modules), rearranging antenna cable connections and calibrating/setting the software coefficients of the one or more additional discrete-coefficients phase-combiners so that the transfer function of the one or more additional transmitter modules match the transfer of the existing RS transfer module(s). The existing transmitter module(s) does not need to be replaced, rather they are reconfigured and reused. Examples of scaling up according to the invention are given below in terms of FIGS. 5-8.

As a practical matter, manufacturing tolerances (e.g., path differences through the transmitter module that induce differences in the phase-changes attributable to the paths, respectively), etc., make it unlikely that an additional transmitter module will be the same as a retained transmitter module. More particularly, manufacturing tolerances affect, e.g., inter-path isolation, i.e., the degree of isolation between neighboring transmission paths through the transmitter module, so that it is not sufficiently uniform. In other words, manufacturing tolerances result in one or more pairs of neighboring paths having isolation (ISOL) that is not sufficiently uniform, e.g., ISOL<30 dB. Having insufficiently uniform inter-path isolation prevents the transfer function of the additional transmitter module from being sufficiently close to the transfer function of the retained transmitter module(s) so as to be considered a “match” (hence, before calibration, the additional transmitter module is referred to as substantially the same). But the digital nature of the additional transmitter module permits a calibration procedure (discussed below) to be performed which can achieve uniform inter-path isolation (e.g., ISOL≧25 dB) in the additional transmitter module, i.e., which can tune the transfer function of the additional transmitter module to be sufficiently close to the transfer function of the retained transmitter module(s) so as to be considered a match.

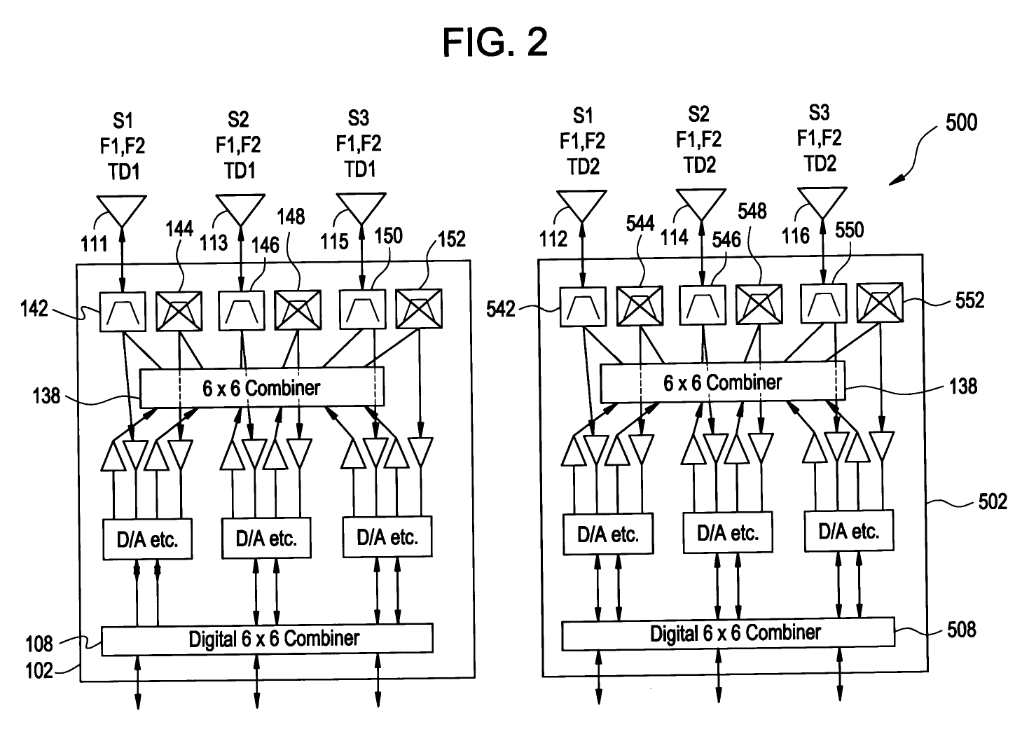

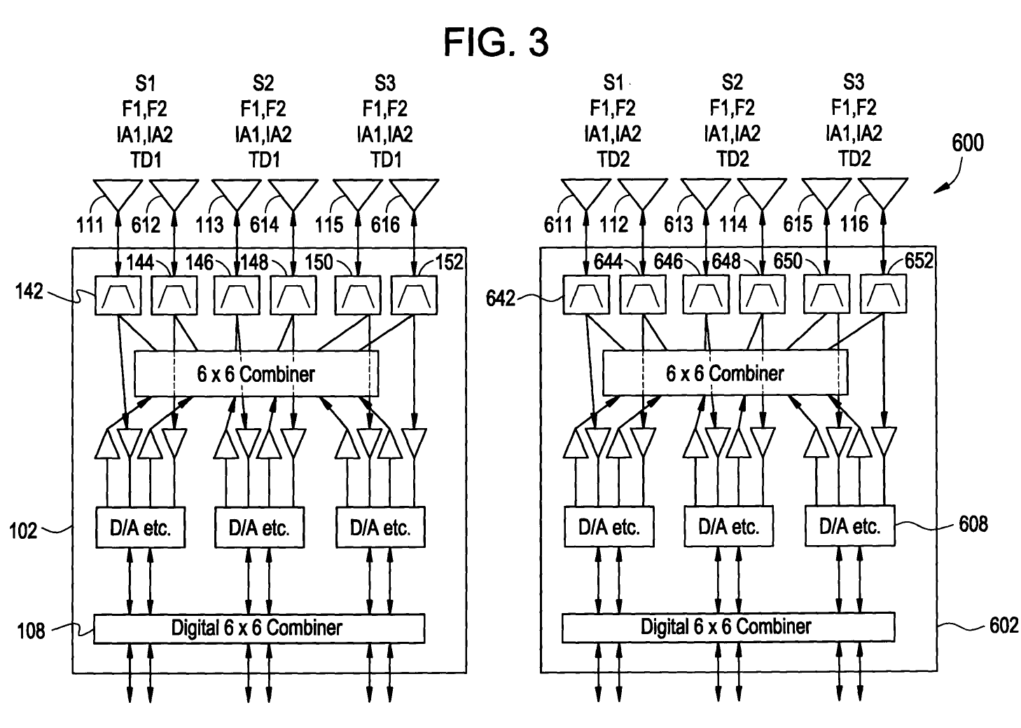

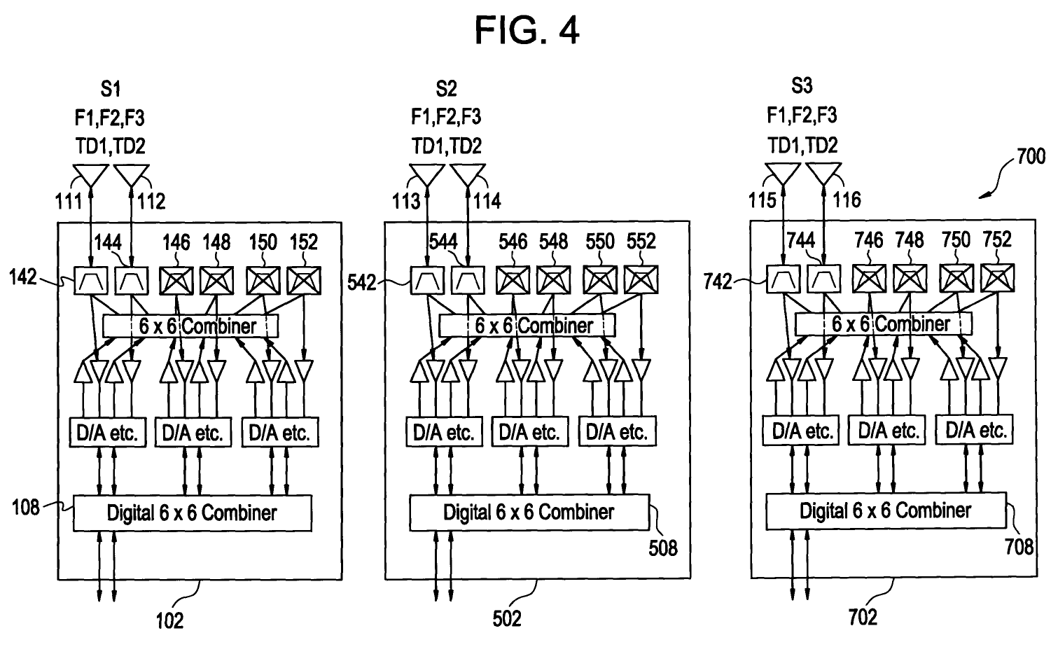

FIGS. 2-5 are block diagrams of other modular transmitter systems. The scalable nature of the transmitter module according to embodiments of the invention makes it possible to reconfigure, e.g., from FIG. 1 to any of FIGS. 2-5 without discarding the transmitter module 102. Other reconfigurations are possible, some of which include: FIG. 2 reconfigured to FIG. 4; FIG. 3 reconfigured to FIG. 5; FIG. 2 reconfigured to FIG. 5; and FIG. 3 reconfigured to FIG. 4. Alternatively, each of FIGS. 2-5 can themselves be starting points from which there can be a reconfiguration, rather than being an outcome of a reconfiguration from, e.g., FIG. 1.

Each of FIGS. 2-5 will now be discussed in terms of an example reconfiguration.

FIG. 2 is a block diagram of a modular transmitter system 500 that uses two carrier frequencies, F1 and F2, and has 3 sectors S1, S2 and S3, with each sector having a first transmit-diversity branch TD1 and a second transmit-diversity branch TD2. The system 500 is assumed to be a reconfiguration of the system 100 of FIG. 1. FIG. 2 bears similarities to FIG. 1, which is reflected in the use of the same or similar item numbers to denote the same or similar items. Each of the antennas 111-116 handles both F1 and F2. Antennas 111-113 handle TD1 while antennas 114-116 handle TD2.

The system 500 includes two transmitter modules 102 and 502. Together, the two transmitter modules 102 and 508 can be considered the RF section of a base station.

A party having a transmitter system 100, that wishes to add a second carrier frequency, F2, can reconfigure the transmitter system 100 into the transmitter system 500 by doing the following. First, the transmitter module 102 is retained for reuse. A second transmitter module 502, substantially the same (but for unavoidable pre-calibration differences due to manufacturing tolerances, etc.) as transmitter module 102, is added relative to system 100. The inputs to the transmitter modules 102 and 502 are connected similarly, respectively.

Connections between the filters 142-152 and the antennas 111-116 are altered so that: filter 142 feeds antenna 111; filter 146 feeds antenna 113; and filter 150 feeds antenna 115. The outputs of the filters 144, 148 and 152 are terminated with impedance-matched dummy loads (IMDLs), as indicated by the large “X” superimposed on the filters 144, 148 and 152. The second transmitter module 502 is connected to antennas 112, 114, 116 in the same manner, i.e., to filters 542, 546 and 550, respectively. And the filters 544, 548 and 552 are terminated with IMDLs. The antenna cables at the top of the unit can be moved around.

After the antenna connections are rearranged, the transmitter module 502 system 500 is calibrated (as will be described below), which sets the coefficients in the discrete-coefficients phase-combiner 508. The calibration of the transmitter module 502 tunes the transfer function (H₅₀₂) of the transmitter module 502 to match the transfer function (H₁₀₂) of the transmitter module 102 despite unavoidable differences due to manufacturing tolerances, i.e., the calibration compensates for the manufacturing tolerances.

It is noted that there can be many arrangements by which the sectors are handled by the antennas 111-116 of FIG. 2. One such example rearrangement is: S1 and TD1 on antenna 111; S1 and TD2 on antennal 112; S2 and TD1 on antenna 113; S2 and TD2 on antenna 114; S3 and TD1 on antenna 115; and S3 and TD2 on antenna 116.

FIG. 3 is a block diagram of a modular transmitter system 500 that uses two carrier frequencies, F1 and F 2, and has 3 sectors S1, S2 and S3, with each sector having a first transmit-diversity branch TD1 and a second transmit-diversity branch TD2, and each TDi branch having a first intelligent antenna branch IA1 and a second intelligent antenna branch IA2. It is assumed that the system 600 is a reconfiguration of the system 100 of FIG. 1. FIG. 3 bears similarities to FIG. 1, which is reflected in the use of the same or similar item numbers to denote the same or similar items. Antennas 111-116 handle TD1 while antennas 611-616 handle TD2. Antennas 111, 112, 611 and 612 handle S1. Antennas 113, 114, 613 and 614 handle S2. And antennas 115, 116, 615 and 616 handle S3.

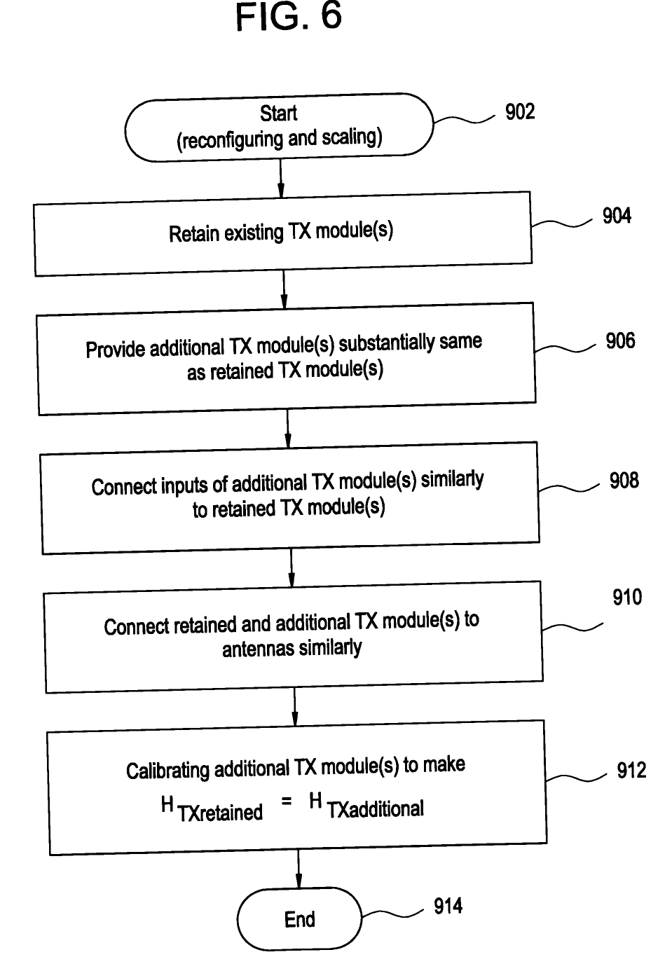

The system 600 includes two transmitter modules 102 and 602, which together can be considered the RF section of a base station. Extending the example of FIG. 1 (where each antenna transmits a signal based upon F1), each of the antennas in FIG. 6 transmits a signal based upon F1 and F2.

A party having a transmitter system 100, that wishes to use a second carrier frequency F2 and to transmit using an intelligent antenna technique can reconfigure the transmitter system 100 into the transmitter system 600 by doing the following. First, the transmitter module 102 is retained for reuse. A second transmitter module 602, substantially the same (but for unavoidable pre-calibration differences due to manufacturing tolerances, etc.) as transmitter module 102, is added relative to system 100. The inputs to the transmitter modules 102 and 602 are connected similarly, respectively.

Six antennas 611-616 are added to the system 600. Connections between filters 142-152 and 642-652 and the to antennas 111-116 and 611-616 are made as follows: filter 142 feeds existing antenna 111, filter 144 feeds new antenna 612, filter 146 feeds antenna 113, filter 148 feeds antenna 614, filter 150 feeds antenna 115, filter 152 feeds antenna 616, filter 642 feeds antenna 611, filter 644 feeds antenna 112, filter 646 feeds antenna 613, filter 648 feeds antenna 114, filter 650 feeds antenna 615, filter 652 feeds antenna 116.

After the antenna connections are made, the transmitter module 602 is calibrated (see discussion below), which sets the coefficients in the discrete-coefficients phase-combiner 608. Again, the calibration components for manufacturing tolerances and tunes the transfer function H₆₀₂ to match H₁₀₂.

It is noted that there can be many arrangements by which the sectors are handled by the antennas 111-116 and 611-616 of FIG. 3. One such example rearrangement is: antenna 111 handles S1, TD1 and IA1; antenna 112 handles S1, TD1 and IA2; antenna 113 handles S1, TD2 and IA1; antenna 114 handles S1, TD2 and IA2; antenna 115 handles S2, TD1 and IA1; antenna 116 handles S2, TD1 and IA2; antenna 611 handles S2, TD2 and IA1; antenna 612 handles S2, TD2 and IA2; antenna 613 handles S3, TD1 and IA1; antenna 614 handles S3, TD1 and IA2; antenna 615 handles S3, TD2 and IA1; and antenna 616 handles S3, TD2 and IA2.

FIG. 4 is a block diagram of a modular transmitter system 700 that uses three carrier frequencies, F1, F2 and F3, and has 3 sectors S1, S2 and S3, with each sector having a first transmit-diversity branch TD1 and a second transmit-diversity branch TD2. It is assumed that the system 700 is a reconfiguration of the system 500 of FIG. 2. FIG. 4 bears similarities to FIGS. 1 and 2, which is reflected in the use of the same or similar item numbers to denote the same or similar items. Each of the antennas 111-116 handles signals base upon F1, F2 and F3, respectively. Antennas 111-112 handle S1. Antennas 113-114 handle S2. Antennas 115-116 handle S3. Extending the example of FIG. 2 (where each antenna transmits a signal based upon F1 and F2 that together represent that has a 10 MHz BW), each of the antennas in FIG. 4 transmits a signal based upon F1, F2 and F3.

The system 700 includes three transmitter modules 102, 502 and 702. Together, the three transmitter modules 102, 502 and 702 can be considered the RF section of a base station.

A party having a transmitter system 500, that wishes to add a third carrier frequency, F3, can reconfigure the transmitter system 500 into the transmitter system 700 by doing the following. First, the transmitter modules 102 and 502 are retained for reuse. A third transmitter module 702, substantially the same (but for unavoidable pre-calibration differences due to manufacturing tolerances, etc.) as transmitter modules 102 and 502 is added relative to system 500. The inputs to the transmitter modules 102, 502 and 702 are connected similarly, respectively.

Connections between the filters 142-152 and the antennas 542-552 are altered so that: filter 142 feeds antenna 111; filter 144 feeds antenna 112; filter 542 feeds antenna 113; and filter 544 feeds antenna 114. The outputs of the filters 146-152 and 544-552 IMDLs. The third transmitter module 702 is connected to antennas 115-116 in the same manner, i.e., to filters 742 and 744, respectively. And the filters 746-752 are terminated with IMDLs.

After the antenna connections are rearranged, the transmitter module 702 is calibrated (see discussion below), which sets the coefficients in the discrete-coefficients phase-combiner 708. Recalling that H₁₀₂ matches H₅₀₂ (after the calibration was performed on the transmitter module 502), the calibration of the transmitter module 702 can compensate for manufacturing tolerances, etc., resulting in H₇₀₂ being tuned to match both H₁₀₂ and H₅₀₂.

It is noted that there can be many arrangements by which the sectors are handled by the antennas 111-116 of FIG. 4. e.g., having each transmitter module handle the same sector but changing which of the filters is connected to the antennas versus being terminated with an IMDL, or having each transmitter module handle signals from different sectors, etc.

FIG. 5 is a block diagram of a modular transmitter system 800 that uses one carrier frequency, F1, and has 3 sectors S1, S2 and S3, with each sector having a first transmit-diversity branch TD1 and a second transmit-diversity branch TD2, and each TDi branch having a first intelligent antenna branch IA1 and a second intelligent antenna branch IA2. It is assumed that the system 800 is a reconfiguration of the system 600 of FIG. 3. FIG. 5 bears similarities to FIGS. 1 and 3, which is reflected in the use of the same or similar item numbers to denote the same or similar items. Antennas 111-116 handle TD1 while antennas 511-516 handle TD2. Antennas 111, 112, 511 and 512 handle S1. Antennas 113, 114, 513 and 513 handle S2. And antennas 115, 116, 515 and 516 handle S3.

The system 800 includes three transmitter modules 102, 602 and 802, which together can be considered the RF section of a base station. Extending the example of FIG. 3 (where each antenna transmits a signal based upon F1 and F2 that together represent having a 10 MHz), each antenna in FIG. 5 transmits a signal based upon F1, F2 and F3 that together represent a BW of 30MHz.

A party having a transmitter system 600, that wishes to use a third carrier frequency F3 and continue to transmit using the intelligent antenna technique can reconfigure the transmitter system 600 into the transmitter system 800 by doing the following. First, the transmitter modules 102 and 602 are retained for reuse. A third transmitter module 802, substantially the same (but for unavoidable pre-calibration differences due to manufacturing tolerances, etc.) as transmitter modules 102 and 602, is added relative to system 600. The inputs to the transmitter modules 102, 602 and 802 are connected similarly, respectively.

Connections between the filters 142-152 and 642-652 and the antennas 111-116 and 611-616 are made as follows: filter 142 feeds antenna 111; filter 144 feeds antenna 612; filter 146 feeds antenna 611; filter 148 feeds antenna 112; filter 642 feeds antenna 113; filter 644 feeds antenna 614; filter 646 feeds antenna 613; and filter 648 feeds antenna 114. The filters 842-848 of the third transmitter module 802 are connected to the remaining antennas 115, 616, 615 and 116 so that: filter 842 feeds antenna 115; filter 846 feeds antenna 616; filter 846 feeds antenna 615; and filter 848 feeds antenna 116. Filters 150, 152, 650, 652, 850, and 852 are terminated with IMDLs.

After the antenna connections are made, the transmitter system 800 is calibrated (see discussion below), which sets the coefficients in the discrete-coefficients phase-combiner 808. Recalling that H₁₀₂ matches H₆₀₂ (after the calibration was performed on the transmitter module 602), the calibration of the transmitter module 802 can compensate for manufacturing tolerances, etc., resulting in H₈₀₂ being tuned to match both H₁₀₂ and H₆₀₂.

Each antenna in FIG. 5 transmits 1.5 times as much power as in FIG. 3 because of the additional carrier frequency F3. Continuing the example, if each antenna in FIG. 3 transmits 20 Watts, then each antenna in FIG. 5 transmits 30 W.

It is noted that there can be many arrangements by which the sectors are handled by the antennas 111-114, 611-614 and 811-814 of FIG. 5, e.g., having each transmitter module handle the same sector but changing which of the filters is connected to the antennas versus being terminated with an IMDL, or having each transmitter module handle signals from different sectors, etc.

The transmitter modules according to embodiments of the invention can be reconnected so as to continue transmitting the maximum power for which they were designed despite the reconfiguration. As an example, a typical UMTS specification is for a transmitter module to transmit 20 W per sector per carrier. Extending the example to FIGS. 1-5 would be as follows. Each antenna 111-116 in FIG. 1 would handle 10 W such that the transmitter module 102 and the system 100 each handle 60 W. Scaling from FIG. 1 to FIG. 2, the system 500 would handle 120 W, with each of the transmitter modules 102 and 502 handling 60 W, and each antenna 111-116 handling 20 W. Scaling up from FIG. 1 to FIG. 3, the system 600 handles 120 W, with each of the transmitter modules 102 and 602 handling 60 W and each of the antennas 111-116 and 611-616 handling 10 W. Scaling up from FIG. 2 to FIG. 4, the system 700 handles 180 W, with each of the transmitter modules 102, 502 and 702 handling 60 W and each of the antennas handling 30 W. Lastly, scaling up from FIG. 3 to FIG. 5, the system 800 handles 180 W, with each of the transmitter modules 102, 602 and 802 handling 60 W and each of the antennas 111-116 and 611-616 handling 15 W.

FIG. 6 is a flowchart of a modular method of reconfiguring a transmitter according to an embodiment of the invention. FIG. 6 generalizes the examples of reconfiguration discussed above regarding FIGS. 2-5. The flowchart applies to situations where there is one or plural existing transmitter modules and/or where one or more additional carrier frequencies is being added to the transmitter system (corresponding to one or more additional transmitter modules, respectively).

Flow begins at block 902 and can continue sequentially to block 914, where flow ends. At block 904, the existing transmitter (TX) module(s) are retained for reuse. At block 906, the additional transmitter module(s) are provided, the additional transmitter module(s) being substantially the same (but for unavoidable pre-calibration differences due to manufacturing tolerances etc.) as the retained transmitter module(s).

At block 908, the inputs of the additional transmitter modules(s) are connected similarly to the retained transmitter module(s), respectively. At block 910, the retained transmitter module(s) and the additional transmitter module(s) are connected similarly to the antennas.

At block 912, the additional transmitter module(s) are calibrated (see discussion below), which sets the coefficients of the discrete-coefficients phase-combiner(s) in the additional transmitter module(s) so that the transfer functions of each additional transmitter module are tuned to match each retained transmitter module.

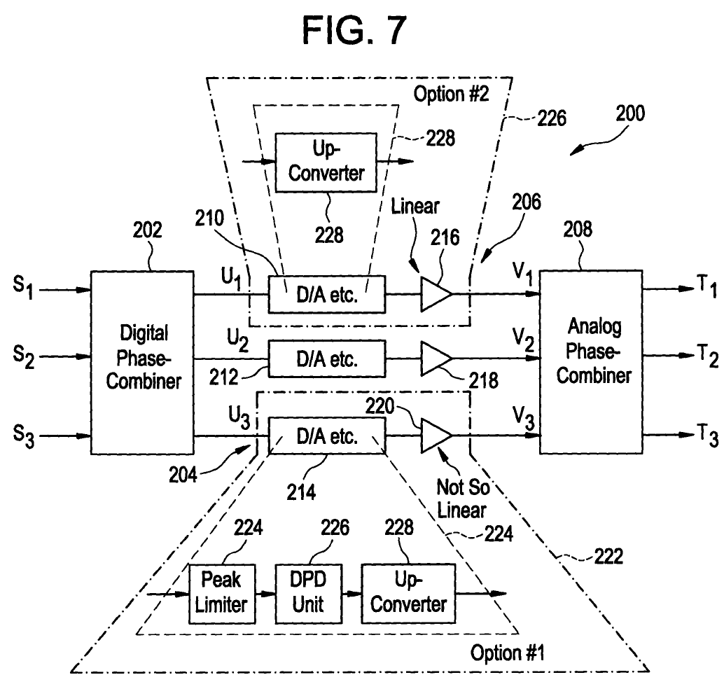

FIG. 7 is a block diagram of another transmitter module according to an embodiment of the invention. For simplicity, the transmitter module 200 has been depicted as a 3-way module, where Q=3. But as discussed above, a transmitter module according to the invention can have other values of Q, namely Q≧2.

The transmitter module 200 includes a Butler-type discrete-coefficients phase-combiner 202, a bank 204 of radio units 210-214, a bank 206 of amplifiers 216-220, and a Butler-type analog-coefficients phase-combiner 208. The module 200 receives signals S₁, S₂ and S₃ and outputs signals T₁, T₂ and T₃, respectively.

In FIG. 7, two options are depicted for implementing the bank 204 of radio units. Option #1 (indicated by item 222, depicted in phantom lines) is for the circumstance in which the bank 206 of amplifiers 216-220 uses lower quality, less expensive amplifiers that have poor linearity performance. For the not-so-linear amplifier scenario (option #1), the radio unit 214 (as indicated by the exploded view 224 depicted in phantom lines) includes a peak limiter unit 224, a digital pre-distortion (DPD) unit 226 and an up-converter 228 (that converts a digital signal to an RF analog signal). The poor linearity performance of the less expensive amplifier module is improved with the application of digital pre-distortion. The up-converter 228, the peak limiter unit 224 and the DPD unit 226 are well known.

Option #2 in FIG. 7 (indicated by item 226 depicted in phantom lines) assumes the circumstance in which the bank 206 of amplifiers 216-220 are linear amplifiers, which are well known. In the linear-amplifier circumstance (option #2), each of the radio units 210-214 (as indicated by the exploded view 228 depicted in phantom lines) in the bank 204 includes the up-converter unit 228, but does not need the peak-limiter unit 224 and the DPD unit 226.

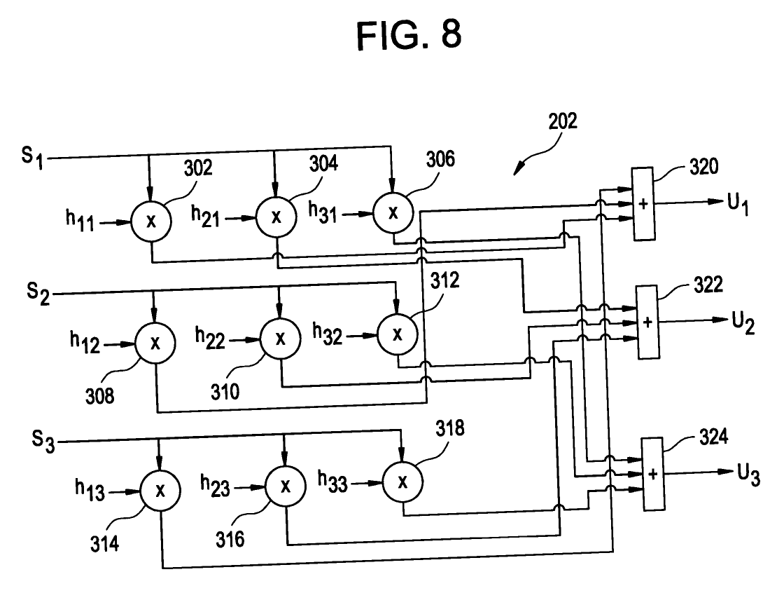

FIG. 8 is a representation of an example transfer function of the discrete-coefficients phase-combiner 202. The combiner 202 receives the input S₁, S₂ and S₃ and outputs the transformed signals U₁, U₂ and U₃, respectively. The discrete-coefficients of an HBB matrix (to be discussed further below) are provided as inputs to multiplier units 302-318. For the example in which the combiner 202 is a 3-way combiner, the H_{BB} matrix is a 3×3 matrix. As such, h₁₁ is input to the multiplier 302, h₂₁ is input to the multiplier 304, . . . h₂₃ is input to the multiplier 316 and h₃₃ is input to the multiplier 318. The input S₁ is fed to each of the multipliers 302-306. The input signal S₂ is fed to each of the multipliers 308-312. The input signal S3 is fed to each of the multipliers 314-318. The product of the multipliers 302, 308 and 314 are fed to a summing unit 320, whose sum represents the output signal U₁. The products of the multipliers 304, 310 and 316 are fed to the summing unit 322, whose output is the signal U₂. The products of the multipliers 306, 312 and 318 are fed to the summing unit 324, whose output is the signal U₃.

The discrete coefficients h₁₁, . . . h₃₃ of the H_{BB} matrix of FIG. 8 can be stored as digital numbers in a memory device and supplied to discrete components representing the multiplier units 302-318 and the summing units 320-324. Alternatively, the representation of FIG. 8 can be implemented via a memory device for the coefficients and programmable logic array (PLA) or ASIC for the units 302-324, or entirely via software running on a general purpose computer.

Reconfigurability of systems using the discrete-coefficients phase-combiner 202 is at least partially attributable being able to calibrate an additional transmitter module (that is being combined with the retained transmitter module) so that the transfer function of the additional transmitter module matches the transfer function of the retained transmitter module. And the ability to easily implement a calibrated transmitter module is at least partially attributable the coefficients h₁, h₂₁, . . . h₂₃ and h₃₃ being stored in software.

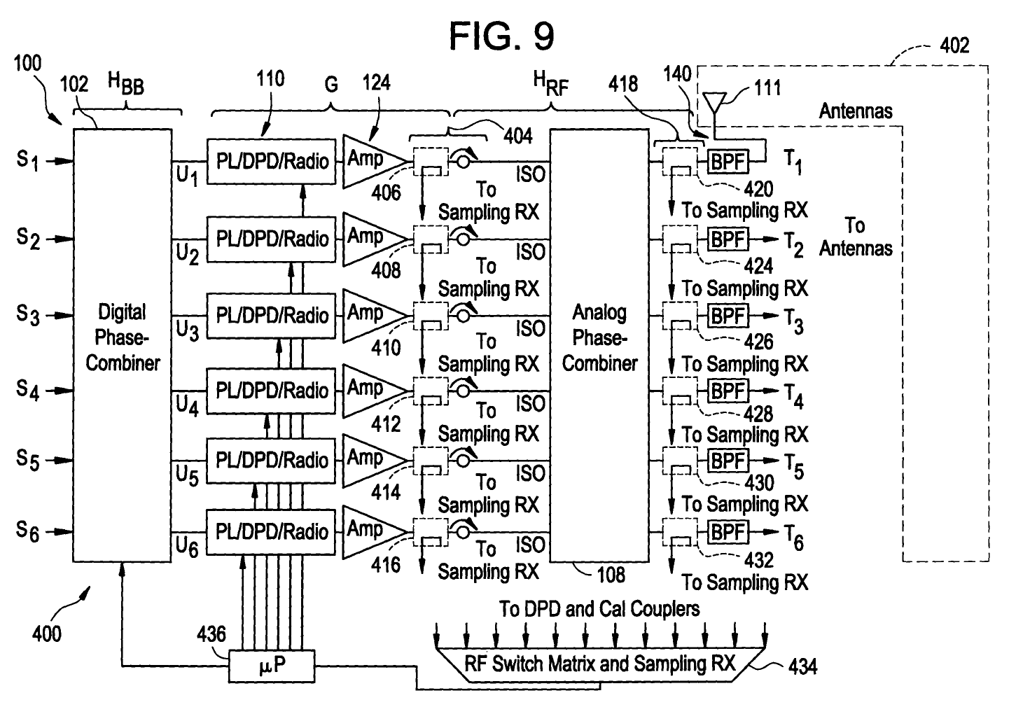

An example of calibrating a transmitter module will be discussed next in terms of FIG. 9.

FIG. 9 is a schematic block diagram of an alternative arrangement 400 of the transmitter module 100 of FIG. 1. The arrangement 400 includes calibration components 404, 418, 434 and 436 by which coefficients of the phase-combiner 102 can be set (and reset) and control parameters can be fed to the radio bank 110. It is noted that implementation option #1 of FIG. 7 has been assumed for the radio bank 110 of conversion units. As such, each of the units in the bank 110 has been given the label “PL/DPD/radio” to indicate that each unit includes a peak limiter 224, a DPD unit 226 and an up-converter 228 (none of 224, 226 nor 228 being depicted in FIG. 9, for simplicity). Also, it is noted that the antennas 142-152 of FIG. 1 are depicted as a block 402 (in phantom lines) for simplicity, although antenna 111 is explicitly depicted.

The transformation of signals S₁-S₆ by the transmitter module 100 will now be explained. In matrix arithmetic notation, the transformation by the transmitter module 100 is shown by the following equation.

T=H_{RF}GH_{BB}S (1)

In Eq. No. 1,

S is the source signal, a column vector having 6 elements, S₁-S₆;

H_{BB} is the transfer function of the reconfigurable discrete-coefficients phase-combiner 102, and is a 6×6 complex matrix whose coefficients are what change when the transmitter module 100 is calibrated;

G is a diagonal 6×6 complex matrix representing the transfer function of the middle section 172, which includes the peak limiting, predistortion, radio, and amplifier, and isolator functions, as well as any phase delays resulting from board layout, etc.;

H_{RF} is the transfer function of the analog-coefficients phase-combiner pair, a 6×6 complex matrix; and

T is the output, an RF signal vector having of 6 elements.

Ideally, H _{BB}=H_{RF}^{T}, where T indicates a conjugate transpose.

One of ordinary skill will understand that the middle section 172 can be implemented in a way such that G is not only a diagonal matrix, but it can be assumed that all elements on the diagonal are the same. Thus, the value of all the elements in matrix G can be applied as a scalar multiplier to Eq. No. 1, yielding Eq. No. 2 as follows:

T=GH_{RF}H_{BB}S (2)

Each of H_{RF}, S and T can be measured. Hence H_{RF} can be found, from which H_{BB}=H_{RF}^{T} can be determined. One of ordinary skill, e.g., in the art of amplitude, phase and delay estimation would understand how to estimate the coefficients of H_{BB}.

In FIG. 9, it is assumed that the characteristics of the analog-coefficients phase-combiner 108 are not known precisely and/or the gains of the amplifier bank 124 are not balanced. Accordingly, to calibrate and configure the discrete-coefficients phase-combiner 102, a sampling receiver 434 can be provided to measure signals at the output of the middle section 172 and at the output of the analog-coefficients phase-combiner 108. A bank 404 of sampling circuits is provided to sample the outputs of the middle section 172 (these outputs being used to calibrate the DPD function) and a bank 418 of sampling circuits is provided to sample the outputs of the analog-coefficients phase-combiner 108 (these outputs being used to calibrate H_{BB}).

Calibration can be performed as follows. With the discrete-coefficients phase-combiner (H_{BB}) disabled, signals Uᵢ=Sᵢ, where 1≦i≦6 (or 1≦i≦Q in cases where Q≠6), and are assumed to be uncorrelated. At the transmitter output (port), T₁, the output signal is given by:

T=H_{RF}GS (3)

Each sampled vector in T is given by

$${T}_{i} ( n ) = {\sum }_{j = 1}^{6} {w}_{i j} {S}_{j} ( n ) \qquad ( 4 )$$

and wᵢⱼ are the elements of H_{RF}G. To derive the unknown elements, it is necessary to correlate the input sampled elements in S to the output T on a row by row basis.

For each set of sampled data atT, 6 elements wᵢⱼ can be derived by correlating across the 6 source signals Sᵢ as follows:

$${w}_{i k} = {\sum }_{n} {\sum }_{j = 1}^{6} {w}_{i j} {S}_{j} ( n ) {S}_{k} ( n - N ) \qquad ( 5 )$$

and N is the bulk group delay through the system. Since all Sᵢ sets are assumed uncorrelated, but not necessarily orthogonal, the signal to noise level will be proportional to the correlation length, and is sufficiently below the port isolation requirements.

After the elements of H_{RF}G are computed, the elements can then normalized, e.g., by the Frobenius matrix norm ||H_{RF}G||_{F}, given by

$${‖ {H}_{RF} G ‖}_{F} = \sqrt{{\sum }_{i , j} {\vert {w}_{i j} \vert}^{2}} . \qquad ( 6 )$$

The discrete-coefficients phase-combiner transfer function is then given by

$${H}_{BB} = \frac{{( {H}_{RF} G )}^{- 1}}{{‖ {H}_{RF} G ‖}_{F}} . \qquad ( 7 )$$

The various samples from the banks 404 and 418 of sampling circuits are provided via the sampling receiver 434 to a processor 436. Based upon the samples from the block 418 of sampling circuits, the processor 436 determines and sets the coefficients of H_{BB}. Also, based upon the samples from the bank 404 of sampling circuits, the processor 436 determines control signals to provide to the DPD units 226 (included PL/DPD/Radio units of bank 110 though not depicted in FIG. 4).

Alternatively, if it is assumed that the characteristics of the analog-coefficients phase-combiner 108 are known, and are assumed to be within a predetermined tolerance, and it is assumed that the amplifier paths are phase and gain balanced via digital predistortion, then it is not necessary to sample the outputs of the analog-coefficients phase-combiner 108 (or provide the bank 418 of sampling circuits), which also reduces the minimum number of ports on the sampling receiver 434 to 6. The discrete-coefficients phase-combiner is then given simply by

H_{BB}=H_{RF}⁻¹. (8)

The predistortion function, performed by the DPD units 226 (included PL/DPD/Radio units of bank 110 though not depicted in FIG. 9) is responsible for phase matching the signal between the bank 124 of amplifiers and the analog-coefficients phase-combiner 108, thus phase-matched cables should be used between the bank 404 of sampling circuits and the sampling receiver 434.

The discussion of scalability has referred to adding additional transmitter module(s) that are substantially the same (before calibration) as the existing transmitter module(s). It should be understood that this does not mean substantially the same down to the component level, rather it means being substantially the same at a higher level, namely in terms of inputs/outputs, transfer functions, etc. This broader sense of the “same” takes into consideration: the likelihood that a manufacturer will improve the quality of an transmitter module (over the lifetime that it is made available by the manufacturer) while keeping it backward compatible in terms of being suitable to be added together with an older version of the transmitter module during a reconfiguration; the likelihood that a second manufacturer might bring a competing transmitter module to market that has different circuitry and yet is compatible in terms of being suitable to be added together with an transmitter module from a first manufacturer during a reconfiguration; etc.

Also, the discussion of scalability has referred to the original transmitter module(s) as having a digital input phase-combiner. Alternatively, the original transmitter module(s) could be entirely analog.

Module 102 is a transmitter in the sense that it receives baseband signals, transforms the signals and outputs the signals to the antennas 111-116. Such transmission flow is depicted by the upward-pointing arrowheads 104, the upward-pointing arrowheads 162, the upward-pointing amplifiers 126-136, the upward-pointing arrowheads 164 and the upward-pointing arrowheads 106. But it is noted that the module 102 can also function as a receiver module that receives signals from the antennas 111-116, transforms them and outputs them as baseband signals. Such a reception path is somewhat the reciprocal of the transmission path except that the reception path does not include the analog-coefficients phase-combiner 138. An example reception path from among the six depicted in module 102 is indicated by the downward-pointing arrowhead 153, the path 154 from the bandpass filter 142 to the downwardly-pointing amplifier 156, the path 158 from the amplifier 156 to the radio unit 118, the downwardly-pointing arrowhead 160 from the radio unit 118 to the discrete-coefficients phase-combiner 108 and the downwardly-pointing arrowhead 161 coming out of the discrete-coefficients phase-combiner 108. FIGS. 2-5 similarly depict receive paths, though these paths have not been individually enumerated, for simplicity.

The invention being thus described, it will be obvious that the same may be varied in many ways. Such variations are not to be regarded as a departure from the spirit and scope of the invention, and all such modifications as would be obvious to one skilled in the art are intended to be included within the scope of the invention.

We claim:

1. A phase-combined transmitter module comprising:
a discrete-coefficients phase-combiner, inputs of the discrete-coefficients phase-combiner representing the inputs to the transmitter module;
an up-conversion and amplification (UCA) unit to receive digital signals from the discrete-coefficients phase-combiner, up-convert and amplify the received signals and output amplified analog signals; and
an analog-coefficients phase-combiner to receive the amplified analog signals from the UCA unit, outputs of the analog-coefficients phase-combiner unit representing outputs of the transmitter module.

2. The transmitter module of claim 1, wherein the UCA unit includes:
an up-converter unit to convert the received signals into a corresponding number of analog RF signals; and
a plurality of linear amplifiers, corresponding in number to the number of analog RF signals, to provide the amplified analog signals.

3. The transmitter module of claim 1, wherein the UCA unit includes:
a signal-processor unit to digitally peak-limit and digitally pre-distort the received signals and output processed signals;
an up-converter unit to convert the received signals into a corresponding number of analog RF signals; and
a plurality of amplifiers, corresponding in number to the number of analog RF signals, to provide the amplified analog signals.

4. The transmitter module of claim 1, wherein at least one of the analog-coefficients phase-combiner and the discrete-coefficients phase-combiner is a Butler-type phase-combiner.

5. The transmitter module of claim 1, wherein the module has at least two inputs and a corresponding number of outputs.

6. The transmitter module of claim 5, wherein the module has 6 inputs and 6 outputs.

7. The transmitter module of claim 6, wherein each transmitter module can accommodate a scheme in which there is
one carrier frequency (F1), and
three sectors to be sourced by each transmitter module,
each sector being supplied with an F1-based, and
each sector consuming 2 of the 6 transmitter module outputs, with a first one of the sector outputs representing a first transmit diversity branch and a second one of the sector outputs representing a second transmit diversity branch.

8. A modular phase-combined transmitter system comprising:
at least two phase-combined transmitter modules, each module including
a discrete-coefficients phase-combiner, inputs of the discrete-coefficients phase-combiner representing the inputs to the transmitter module,
an up-conversion and amplification (UCA) unit to receive digital signals from the discrete-coefficients phase-combiner, up-convert and amplify the received signals and output amplified analog signals, and
an analog-coefficients phase-combiner to receive the amplified analog signals from the UCA unit, outputs of the analog-coefficients phase-combiner unit representing outputs of the transmitter module.

9. The transmitter system of claim 8, wherein the UCA unit includes:
an up-converter unit to convert the received signals into a corresponding number of analog RF signals; and
a plurality of linear amplifiers, corresponding in number to the number of analog RF signals, to provide the amplified analog signals.

10. The transmitter system of claim 8, wherein the UCA unit includes:
a signal-processor unit to digitally peak-limit and digitally pre-distort the received signals and output processed signals;
an up-converter unit to convert the received signals into a corresponding number of analog RF signals; and
a plurality of amplifiers, corresponding in number to the number of analog RF signals, to provide the amplified analog signals.

11. The transmitter system of claim 8, wherein at least one of the analog-coefficients phase-combiner and the discrete-coefficients phase-combiner is a Butler-type phase-combiner.

12. The transmitter system of claim 8, wherein each module has at least two inputs and a corresponding number of outputs.

13. The transmitter system of claim 12, wherein the module has 6 inputs and 6 outputs.

14. The transmitter system of claim 13, wherein:
the transmitter includes two transmitter modules such that there are a total of 12 transmitter system outputs; and
together the two transmitter modules accommodate a scheme in which there is
a first carrier frequency (F1) and a second carrier frequency (F2), and
three sectors to be sourced by each transmitter module
each sector being supplied with an F1-based signal and an F2-based signal, and
each sector consuming 2 of the 12 transmitter system outputs and feeding two antennas, respectively, with a first one of the sector outputs representing a first transmit diversity branch and a second one of the sector outputs representing a second transmit diversity branch.

15. The transmitter system of claim 14, wherein the system takes on either of the following configurations,
a first configuration in which
the first transmitter module accommodates the first transmit diversity branches for each sector,
the second transmitter module accommodates the second transmit diversity branches for the second sector, and
each module sources three antennas and has the other three outputs terminated in a dummy load;
a second configuration in which
the first transmitter module accommodates the first and second transmit diversity branches for the first sector and the first transmit diversity branch for the second sector, and
the second transmitter module accommodates the first and second transmit diversity branches for the third sector and the second transmit diversity branch for the second sector; or
a third configuration in which
the first transmitter module accommodates the first transmit diversity branches for each sector,
the second transmitter module accommodates the second transmit diversity branches for the second sector, and
each transmit diversity branch for each sector sources a pairing of intelligent antennas such that each of the 6 outputs of each transmitter module sources an intelligent antenna, respectively.

16. The transmitter system of claim 13, wherein:
the transmitter includes three transmitter modules such that there are a total of 18 transmitter system outputs; and
together the three transmitter modules accommodate a scheme in which there is
a first carrier frequency (F1), a second carrier frequency (F2) and a third carrier frequency (F3), and
three sectors to be sourced by each transmitter module,
each sector being supplied with an F1-based signal, an F2-based signal and an F3-based signal, and
each sector consuming 2 of the 18 transmitter system outputs and feeding two antennas, respectively, with a first one of the sector outputs representing a first transmit diversity branch and a second one of the sector outputs representing a second transmit diversity branch.

17. The transmitter system of claim 16, wherein the system takes on one of the following configurations,
a first configuration in which
each transmitter module accommodates a sector, respectively,
each transmit diversity branch for each sector sourcing a pair of antennas such that each module sources two antennas and has the other four outputs terminated in a dummy load;
a second configuration in which
each transmitter module accommodates two transmit diversity branches,
the two transmit diversity branches accommodated by each transmitter module corresponding to different sectors,
each transmit diversity branch for each sector sourcing a pair of antennas such that each module sources two antennas and has the other four outputs terminated in a dummy load; or
a third configuration in which
each transmitter module accommodates a sector, respectively,
each transmit diversity branch for each sector sourcing a pair of intelligent antennas such that each module sources four antennas and has the other two outputs terminated in a dummy load;

18. A method of modularly reconfiguring a first transmitter system having M transmitter modules where M is an integer and M≧1, the first system having been configured to accommodate a first set of N carrier frequencies where N is an integer and N≧1, into a second transmitter system that can accommodate a set of N+K carrier frequencies where K is an integer and K≧1, the first transmitter system sourcing a plurality of antennas,
the method comprising:
retaining the M transmitter modules; and
providing K additional transmitter modules that are substantially the same as the M retained transmitter modules;
connecting the inputs of the M+K transmitter modules similarly;
connecting the outputs of the M+K transmitter modules to the plurality of antennas similarly; and
calibrating coefficients of each of the K additional transmitter modules in order to make the transfer function of each of the K additional transmitter modules match the transfer function of the M retained transmitter modules.

19. The method of claim 18, wherein each of the M+K modules has 6 inputs and 6 outputs.

20. The method of claim 18, wherein M, N and K take one of the following combinations: M=1, N=1 and K=1; M=1, N=1 and K=2; or M=2, N=2 and K=1.

21. The method of claim 18, further comprising:
altering connections between some of the outputs of the M transmitter modules and some of the plurality of antennas;
wherein the connecting of outputs of the K transmitter modules to the plurality of antennas is done in a manner corresponding to the altered connections of the M transmitter modules.

22. A reconfigured phase-combined transmitter system comprising:
at least one original transmitter module; and
at least one additional transmitter module added during the reconfiguration;
each original transmitter module having
an input phase-combiner, inputs of the phase-combiner representing the inputs to the original transmitter module,
a middle section to at least amplify signals from the input phase-combiner, and
an analog-coefficients phase-combiner to receive the amplified signals from the middle section, outputs of the analog-coefficients phase-combiner unit representing outputs of the original transmitter module; and
each additional transmitter module having
a discrete-coefficients phase-combiner, inputs of the discrete-coefficients phase-combiner representing the inputs to the additional transmitter module,
an up-conversion and amplification (UCA) unit to receive digital signals from the discrete-coefficients phase-combiner, up-convert and amplify the received signals and output amplified analog signals, and
an analog-coefficients phase-combiner to receive the amplified analog signals from the UCA unit, outputs of the analog-coefficients phase-combiner unit representing outputs of the transmitter module,
coefficients of the discrete-coefficients phase-combiner having been tuned so that the transfer function of each additional transmitter module matches the transfer function of the at least one original transmitter module.

23. The transmitter system of claim 22, wherein
the input phase-combiner is a discrete-coefficients phase-combiner that outputs digital signals;
the middle section is an up-conversion and amplification (UCA) unit to receive digital signals from the discrete-coefficients phase-combiner, up-convert and amplify the received signals.
